(19) United States
(12) Patent Application Publication
(10) Pub. No.: US 2013/0235757 A1
(43) Pub. Date: Sep. 12, 2013

(54) APPARATUS AND METHOD FOR A BIOLOGY INSPIRED TOPOLOGICAL PHASE TRANSITION FOR WIRELESS SENSOR NETWORK

(71) Applicant: Shu WANG, Richardson, TX (US)

(72) Inventor: Shu WANG, Richardson, TX (US)

(73) Assignee: SAMSUNG ELECTRONICS CO. LTD., Suwon-si (KR)

(21) Appl. No.: 13/414,049

(22) Filed: Mar. 7, 2012

(51) Int. Cl. H04W 16/00

(52) U.S. Cl. 370/254

(57) ABSTRACT

An apparatus and a method for a topological phase transition of a Wireless Sensor Network (WSN) are provided. The method includes determining an optimal topological phase of the WSN, and at each wireless sensor node, establishing connections to other wireless sensor nodes in the WSN in accordance with the determined optimal topological phase.

### BACKGROUND OF THE INVENTION

1. Field of the Invention

The present invention relates to an apparatus and method for a biology inspired topological phase transition for wireless sensor networks. More particularly, the present invention relates to an apparatus and method for dynamically optimizing phase transitions between different topological phases of a wireless sensor network.

2. Description of the Related Art

A Wireless Sensor Network (WSN) according to the related art consists of spatially distributed autonomous sensors to monitor physical or environmental conditions. The sensors may, for example, monitor criteria such as temperature, sound, vibration, pressure, motion, or pollutants. The sensors are networked to cooperatively pass their data through the network to an access point such as a base station. By using wireless transceivers, the sensors can be placed as needed where a wired sensor might otherwise be limited, such as over a large area or within rotating contexts. WSNs can be bi-directional, enabling control of sensor activity. Such networks are often used in various industrial and consumer applications, such as industrial process monitoring and control, machine health monitoring, and so on.

The WSN is built of “nodes,” where each node is connected to one or more sensors. Each such sensor network node has typically several parts: a radio transceiver with either an internal antenna or a connection to an external antenna, a microcontroller, an electronic circuit for interfacing with the sensors, and an energy source, usually a battery or an embedded form of energy harvesting. A sensor node might theoretically be constructed in varying sizes, from approximately that of a shoebox down to the size of a grain of dust, although functioning “motes” of genuine microscopic dimensions have yet to be created. The cost of sensor nodes is similarly variable, ranging from a few to hundreds of dollars, depending on the complexity of the individual sensor nodes. Size and cost constraints on sensor nodes result in corresponding constraints on resources such as energy, memory, computational speed and communications bandwidth. The topology of WSNs can take various forms, such as a hierarchical star network, a scale-free network, or a randomly connected graph. Propagation techniques between hops of a WSN can include routing or flooding.

Sensor networks differ from traditional wireless mesh networks and ad hoc networks in several ways. These networks operate with severe energy constraints and redundant data. Data aggregation has been put forward as a useful solution to these problems. Data aggregation exploits the fact that a sensor node consumes less energy for information processing than for communication. It minimizes the number of transmissions and thereby saves energy. Instead of transmitting the packets of each individual node separately, each sensor node first combines the incoming data from different sources en-route and then forwards the aggregated information to the next node when its aggregation interval is reached.

In a sensor network, the interplay between topology formation and data aggregation is very important. Traditional data aggregation methods separate the topology formation and data aggregation from each other: a topology is usually formed first, and the data aggregation is then performed based on the topology. However, the pre-constructed topologies are not always the best structures for efficient data aggregation. For example, in FIG. 6, a shorted path tree, one of the most common aggregation topologies, is constructed for collecting sensor data from Nodes 1, 2, and 3, and forwarding the collected data to a sink node. By following the shortest paths, the packets from Nodes 1, 2, and 3 are routed separately to the sink and not able to be aggregated en-route. This means a data-aggregation driven topology is needed for efficient data aggregation.

In 2011, the technique for forming a self-organizing aggregation driven sensor network has been proposed by the present inventor in the article, “Techniques for self-organizing activity-diffusion-based wireless sensor network,” http://patents.com/us-8023501.html. In this approach, each node is like a neuron. When the node starts data aggregation, it simultaneously spreads its activity diffusion messages to its neighbors in a next layer. Each node in the next layer will accumulate the activity diffusion weights, and become an aggregation candidate node if its diffusion weight is greater than a threshold. When a node in the previous layer finishes its data aggregation, it selects its neighbor from the “aggregation candidate nodes” in the next layer. By using the activity diffusion approach, it dynamically forms an aggregation-driven topology to encourage temporal (meet at the same time) and spatial (meet at the same place) data aggregation. However, in this approach, each sensor node has to find its next hop each time its aggregation interval is up. For each sensor node, during each aggregation interval, multiple activity diffusion messages are exchanged with its neighbor sensor nodes to find an aggregation-optimized next hop. If the sensor's node aggregation interval is short, the frequent message exchanges can consume sensor energy. A more energy-efficient activity diffusion based sensor network is therefore needed.

To realize energy-efficient activity diffusion based sensor network, various network topologies are preferred for different circumstances. For example, when the WSN is initially in a setup phase, each node needs to explore all the possible next hop connections to find the optimized data aggregation connection candidates. During this phase, each node needs to establish more connections. After the optimized data aggregation candidate nodes among the connections are identified, the WSN can transit to only exploring the optimized data aggregation candidate nodes (i.e., transition to fewer connections). As the WSN becomes more stable and each sensor node learns more about their data aggregation results with respective optimized candidates, they can determine a best optimized next hop connection (e.g., fixed minimum connection). In this way, WSN topology can be optimized for data aggregation and at the same time, can also ensure power conservation.

One network topology is the scale-free network. A general formula for the degree distribution in scale-free networks can be given as

P=cD^{-α} (1)

where P is a probability of a given degree in the network, c is a constant, D is the degree, and α is the scaling exponent. Topological phase transitions can be described as a gradual change in the exponent α. The exponent starts from 1 (denoting random network), grows until approximately 4 (denoting scale-free networks), and then grows further to higher numbers, showing the presence of fewer and fewer hubs, each with more and more connections. As the scaling exponent a becomes larger, the degree distribution will shift towards an exponential decrease, implying a rapidly decreasing number of highly connected elements, and reaching a star phase topology as an extreme case.

To maintain network stability, a network will ideally be connected to such a degree that signals can easily be transmitted throughout the network, but also only to a degree that noise (undesired perturbations) will dissipate within a confined area of the network, rather than cascading throughout the network. That is, there are circumstances where a high degree of connectivity may be desired, for example, in order to communicate information quickly and easily even when some nodes or connections fail, and other circumstances where a much lower degree of connectivity may be desired, for example, to prevent local problems from triggering a catastrophic failure of the entire network.

However, the related art has not known any nodes or WSNs that dynamically determine an optimized network topology according to conditions, and that transition from one phase topology to another accordingly.

Therefore, there is a need for an apparatus and method for providing a topological phase transition of a wireless sensor network.

### SUMMARY OF THE INVENTION

Aspects of the present invention are to address at least the above-mentioned problems and/or disadvantages and to provide at least the advantages described below. Accordingly, an aspect of the present invention is to provide an apparatus and method for method for a topological phase transition of a Wireless Sensor Network (WSN).

In accordance with an aspect of the present invention, a method for a topological phase transition of a Wireless Sensor Network (WSN) comprising a plurality of wireless sensor nodes is provided. The method includes determining an optimal topological phase of the WSN, and at each wireless sensor node, establishing connections to other wireless sensor nodes in the WSN in accordance with the determined optimal topological phase.

In accordance with another aspect of the present invention, an apparatus for a wireless sensor node for a WSN comprising a plurality of the wireless sensor nodes is provided. The apparatus includes a controller for controlling operations of the node, a wireless transmitter for transmitting communications from the node, a wireless receiver for receiving communications, a sensor unit for sensing sensor data, and a memory unit for storing the sensor data, wherein the controller controls the node to connect to other nodes or to an external WSN access point in accordance with a determined optimal topological phase of the WSN.

In accordance with still another aspect of the present invention, an apparatus for a WSN comprising a plurality of wireless sensor nodes is provided. The apparatus includes a plurality of wireless sensor nodes, wherein each wireless sensor node dynamically connects to other wireless sensor nodes in accordance with a determined optimal topological phase.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 depicts a random graph topology of wireless sensor nodes in a Wireless Sensor Network (WSN) according to an exemplary embodiment of the present invention;

FIG. 2 depicts a disconnected subgraph topology of wireless sensor nodes according to an exemplary embodiment of the present invention;

FIG. 3 depicts a star graph topology of wireless sensor nodes in a WSN according to an exemplary embodiment of the present invention;

FIG. 4 depicts a scale-free network topology of wireless sensor nodes in a WSN according to an exemplary embodiment of the present invention;

FIG. 5 is a block diagram of a wireless sensor node according to an exemplary embodiment of the present invention;

FIG. 6 is an example of data aggregation using a shorted path tree structure according to the related art;

FIG. 7 is an example of activity diffusion according to an exemplary embodiment of the present invention;

FIG. 8 is an example of diffusion weight calculation according to an exemplary embodiment of the present invention; and

FIG. 9 is an example of aggregation-driven topology formation according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention include an apparatus and method for providing a topological phase transition of a wireless sensor network.

Exemplary embodiments of the present invention are self-organizing. Each sensor node acts locally based on its local knowledge. All nodes of a Wireless Sensor Network (WSN) collectively act together to reach a global goal that they each contribute to. A globally coherent pattern appears from the local interaction of the elements that make up the system; thus, the organization is achieved in a way that is parallel (all elements act at the same time) and distributed (elements act independently; no element is a central coordinator). Human cells are an example of a self-organizing system, in that each cell acts locally, but all cells together form the complicated functionality of a human being.

Similarly, each sensor node of an exemplary embodiment of the present invention makes a connection decision based on its local knowledge. The local knowledge may be based on interactions with neighbor sensor nodes, reflected in connectivity status, connectivity history, connectivity aggregation weights, etc. Thus, from a global perspective, all sensor nodes in an exemplary embodiment act together to reach a global goal of adaptive and self-organizing topological phase transition.

Connectivity status, connectivity history, and connectivity aggregation weights are possible examples of local internal states of each sensor node. Each sensor node of an exemplary embodiment of the present invention makes decisions according to internal states, and acts locally. Collectively, all the sensor nodes' local interactions realize a whole WSN topological phase transition.

As discussed above, for a network to provide useful functionality, it must have a sufficient degree of connectivity that it can communicate signals through the network. However, too much connectivity leaves a network vulnerable to catastrophic failures. That is, local perturbations (noise) can accumulate if not dissipated, until they cause a local failure. If the degree of connectivity is too high, the local failure might cascade and rapidly cause failure of the entire connected network. Thus, a network has greater stability if the general functionality, as denoted by the degree of connectivity, is limited to prevent cascading failures.

Networks may undergo a series of interesting transformations called topological phase transitions. A topological phase transition occurs if the continuous increase in the number of perturbations provokes a singular change in the global topology of the network. The global topology is measured by G/N, where G is the size of the largest connected component of the network and N is the total number of its links. For example, in biology metabolic network, it goes through topological phase transitions from random graph→scale-free→star phase→disintegrated subgraph phase as resources become more and more limited or stress grows.

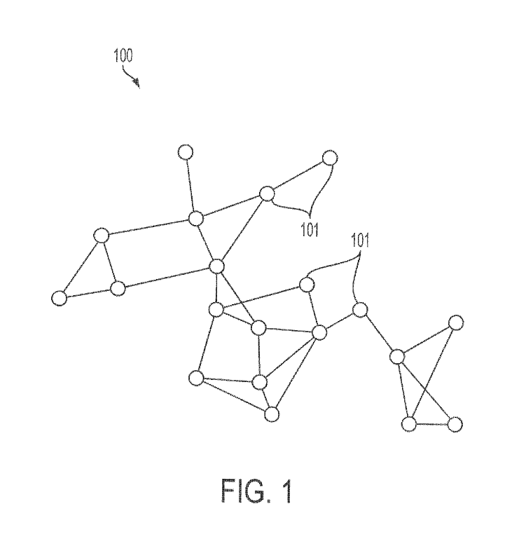

FIG. 1 depicts a random graph topology of wireless sensor nodes in a WSN according to an exemplary embodiment of the present invention. Referring to FIG. 1, if the nodes 101 form connections to whatever other nodes 101 are detected in range, then the network 100 will be random. A random network 100 will connect all nodes 101 if no nodes 101 or subgraphs are isolated. That is, the random network 100 can be thought of as including all nodes 101 in a single subgraph or group. A random network 100 uses a large amount of resources to form all possible connections, but has an advantage of achieving full network connectivity, if possible.

In an analogous biological metabolic network, when outside resources are abundant, the outside resources provoke a shift in the metabolic network towards the random graph phase. In the random graph phase, the cell has exponential growth, low noise, and uniformity.

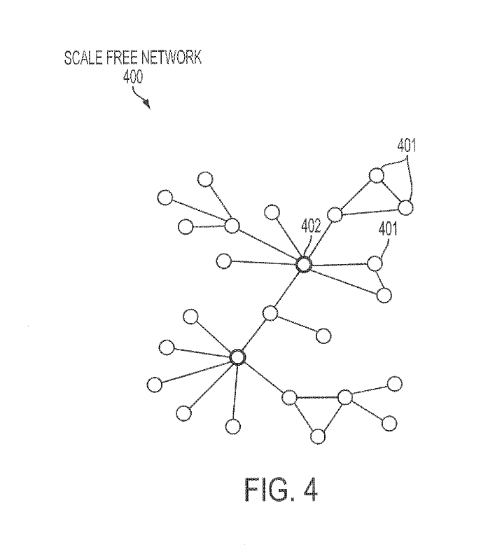

FIG. 4 depicts a scale-free network topology of wireless sensor nodes in a WSN according to an exemplary embodiment of the present invention.

Referring to FIG. 4, an exemplary scale-free network 400 is shown. The defining characteristic of a scale-free network 400 is a network whose degree distribution follows a power law, at least asymptotically. That is, a fraction P(k) of nodes 401 in the network having k connections to other nodes 401 goes for large values of k as

P(k)˜ck^{-γ} (2)

where c is a normalization constant and γ is a parameter whose value is typically in the range 2<γ<3, although it may also lie outside these bounds.

The scale-free property strongly correlates with the network's robustness or resistance to failure. The scale-free network 400 will have a small number of nodes 402 with very high connectivity (major hubs) and more nodes 401 with a lower connectivity, with the largest portion of nodes 401 having the least connectivity. This hierarchy allows for a fault tolerant behavior. If failures occur at random and the vast majority of nodes are those with a small degree of connectivity, then the likelihood that a major hub would be affected is almost negligible. Even if a hub failure occurs, the network will generally not lose its connectedness, due to the remaining hubs.

The scale-free phase is the next lowest energy state after the random graph phase. The scale-free phase WSN 400 has nodes 401 with generally fewer connections to other nodes 401 than they would have in the random graph phase. That is, if nodes in the random graph phase establish all possible connections, the nodes in the scale-free phase will usually have a pared down set of connections in comparison. The scale-free network is between the star network and the random graph in terms of both its stability and its robust resistance to failure. Many empirically observed networks appear to be scale-free, including the worldwide web, the Internet, citation networks, some social networks, airline routes, etc. In WSNs, scale-free networks 400 can enable efficient sensor operations (e.g., data aggregation). To form the scale-free sensor networks 400, a “preferential attachment” approach can be applied. Preferential attachment means that the more connected a node is, the more likely it is to receive new links.

In an analogous biological metabolic network, if resources are reduced and the biological cell experiences a low level of stress, a scale-free metabolic network develops. In the scale free network, there is higher noise, some proteins—as elements of the cellular network—become damaged by a few perturbations, and the repair system provided by chaperones is gradually overloaded, leading to several deviant responses. Consequently, cellular diversity starts to develop.

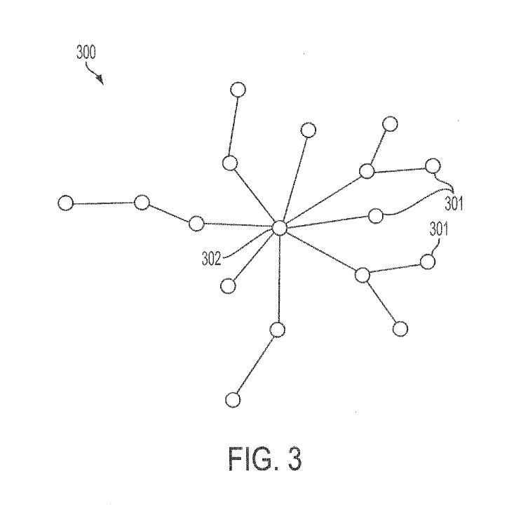

FIG. 3 depicts a star graph topology of wireless sensor nodes in a WSN according to an exemplary embodiment of the present invention.

Referring to FIG. 3, a star network 300 is formed when each node 301 of a level connects to exactly one upper level node 301. The central node 302 is distinguished from other nodes 301 only in that it acts as the access point to the WSN, typically through connection to a base station. Although the central head 302 is depicted in the center of the star network 300, this is a logical depiction only; the central node 302 may be physically located on a periphery of the WSN, for example. Multiple nodes 301 may connect to the same central node 302, and the star can be multiple levels deep. The star network 300 may be represented as a tree structure, with the highest level central node 302 (access point) as the root, sometimes referred to as a Sink Node. A star network topology routes all communications to or from the Sink node.

The star phase is the next lowest energy topology after the scale-free network, and is the lowest energy fully connected network phase. As the sensor nodes' 301 energy is reduced to a lower energy level, the wireless system resources grow critical and the WSN transitions from a scale-free phase to the star phase. In this way, the WSN can concentrate its energy for a minimal set of vital functions. Since nodes in the Star Topology have the minimum connections, the star topology might not be as stable as multi-connection networks (such as the random and scale free networks) in the case where one or more nodes are damaged.

In an analogous biological metabolic network, with higher stress levels, system resources grow critical. The cell has to concentrate its energy in the form of Adenosine Tri-Phosphate (ATP) consumption for a minimal set of vital functions, and the metabolic network will shift towards the star phase from scale free network.

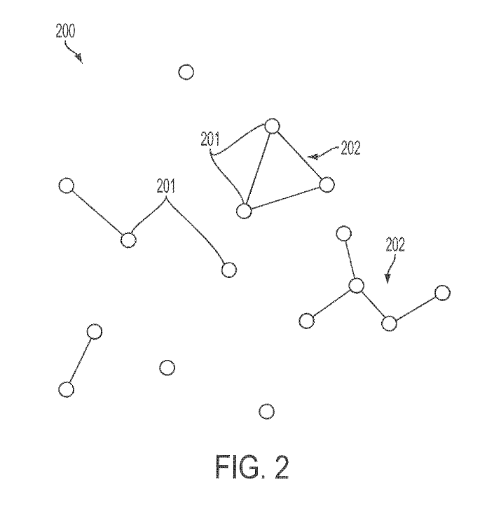

FIG. 2 depicts a disconnected subgraph topology of wireless sensor nodes according to an exemplary embodiment of the present invention.

Referring to FIG. 2, the simplest “network” 200 is if the nodes 201 are at most connected to one or more nearby nodes in groups or subgraphs 202, but the groups 202 do not all connect to each other. That is, it is not possible for information to be transmitted throughout all nodes 201 of the network.

In an analogous biological metabolic network, if system resources go below a critical level or noise becomes too great, too many damaged proteins develop, the biological metabolic network begins to disintegrate into subgraphs, and the related-affected cell dies from apoptosis or necrosis.

It is clear that, in general, an ideal WSN topology can vary according to resources the wireless sensor node has available (such as battery power, transceiver range, bandwidth capacity, connections to other nodes that can be maintained, etc.) and performance requirements (quality of data to be transmitted/relayed, quantity of data to be transmitted/relayed, urgency of data to be transmitted/relayed, etc.). No single topology can be optimal for all WSNs in all conditions, and it is often the case that no single topology can be optimal for a particular WSN in all conditions.

The present invention applies the general idea of biology topological phase transition to an Activity Diffusion based WSN. More particularly, an algorithm to enable an Activity Diffusion based WSN to go through different topological phase transitions (e.g., random→scale free→star topology) as the sensor nodes go through different aggregation periods (e.g., initial→relative stable→stable) is provided.

In the present application it is assumed for purposes of explanation that sensor nodes are location-aware. The location information is attainable, for example, by receiving GPS signals; alternatively, existing distance or hop count techniques may be used.

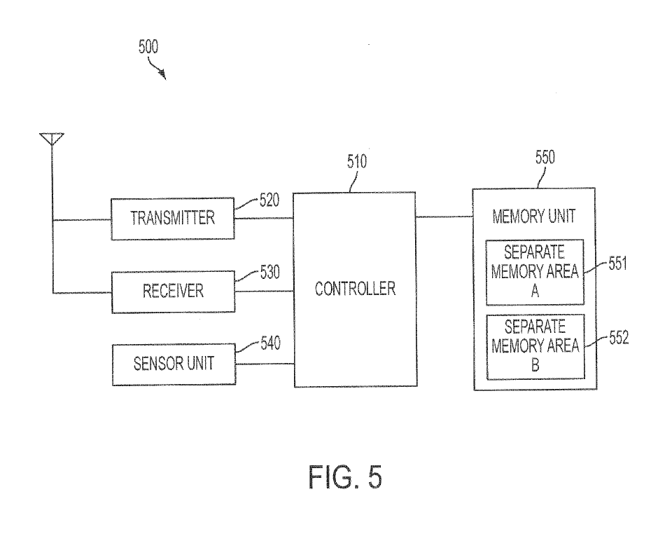

FIG. 5 is a block diagram of a wireless sensor node according to an exemplary embodiment of the present invention.

Referring to FIG. 5, a wireless sensor node 500 for a WSN according to an exemplary embodiment of the present invention includes a controller 510, a transmitter 520, a receiver 530, a sensor unit 540, and a memory unit 550. The controller 510 controls all functions of the wireless sensor node 500. The transmitter 520 transmits communications to other nodes 500, or to an external base station. The receiver 530 receives communications from other nodes 500, or from the external base station. In some implementations, the receiver 530 may also perform a function as a power scavenging unit to directly power the wireless sensor node 500 or to recharge a battery. The communications may include, for example, sensory data or node commands. The memory unit 550 may include a separate memory area A 551 for an Operating System (OS) of the node 500, and a separate memory area B 552 for collected sensor data. The separate memory area A 551 for the OS should be nonvolatile, and optionally may be integrated on a chip of the controller 510. Because the wireless sensor node 500 will typically be made of small size, low power consumption, and few specialized functions, the OS may be correspondingly small and simplified for the specific model of wireless sensor node 500. The sensor unit 540 includes one or more sensors to gather sensor data. The sensors may be of one or more types, such as a temperature sensor and a vibration sensor, for example. The sensor unit 540 may be configured to collect sensor data whenever the sensor unit 540 is powered up. Alternatively, the controller 510 may control the sensor unit 540 to collect sensor data only when the controller 510 determines.

In an exemplary embodiment, when the wireless sensor node 500 powers up, the controller 510 will first load the OS from the memory unit 550. Then according to the OS programming, the wireless sensor node 500 will attempt to find and join a WSN accordingly.

In accordance with an exemplary embodiment of the present invention, the wireless sensor node 500 can also shift from one network topology to another. The change in topology includes determining how many other nodes within range the wireless sensor node 500 should connect to, what characteristics the other nodes must have for connection, and attempting to establish the connections to the other nodes according to the new network topology.

The wireless sensor node 500 may determine when to change network topologies and what network topology to change to. The determination may be, for example, periodic according to a clock, according to a state of the wireless sensor node 500, in response to an instruction received through receiver 530, or according to other criteria.

In one example, the wireless sensor node 500 may be part of a WSN located in a wilderness area such as a forest or mountain. The wireless sensor node 500 may therefore use sunlight to recharge a battery that is not often, if ever, replaced, and may therefore determine to transition to a low energy network topology at night when there is no sunlight available, and to a high energy/high complexity network topology during the day when sunlight provides excess power. Thus, the transition might be determined at least partly on a basis of an internal clock, of a battery charge/discharge rate, or of sensor data of detected light, for example.

A more detailed explanation of a topology phase transition according to an exemplary embodiment of the present invention will now be described.

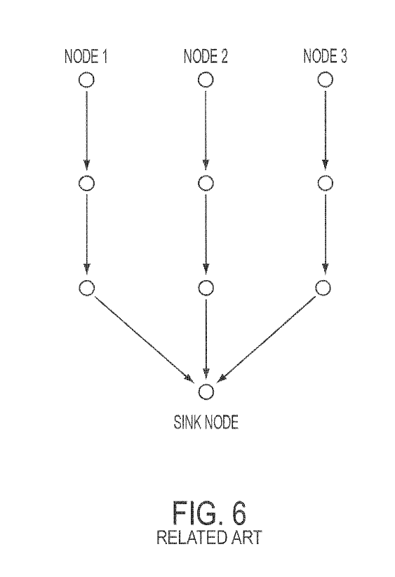

FIG. 6 is an example of data aggregation using a shorted path tree structure according to the related art.

Referring to FIG. 6, the standard star topology network is depicted. Node1, Node2, and Node3 have each connected to one neighboring node that provides a path to the sink node, which is the network access point. This topology is sometimes a preferred or optimal topology, such as for data aggregation. However, other topologies may be preferred under different circumstances. Further, in the related art, a node establishes a connection to a path to the sink node and then maintains that connection. Although a path to the sink node might be dynamically optimized according to various criteria, the related art does not provide dynamic optimization.

In an exemplary embodiment of the present invention, the random graph phase is the initial state in WSNs. That is, the nodes initially communicate with each other in order to determine all other nodes that they can connect to. In this state, sensor nodes have a high energy level and are able to connect to any sensor nodes of next-layer sensor layers with equal probability. Each node does not have any fixed next hop connection.

In this phase, the existing activity diffusion based algorithm is applied to find a next hop for optimized data aggregation. For each aggregation interval, it probes all its next hop neighbors, and chooses next hop for data aggregation based on activity diffusion probe results.

While a sensor node or group of sensor nodes are active and start data aggregation, their activity will simultaneously influence their next-hop neighbor formation via activity diffusion. Image a wave-front, when a node is in the aggregation status, its activity is diffused as a wave-front to its immediate neighborhoods.

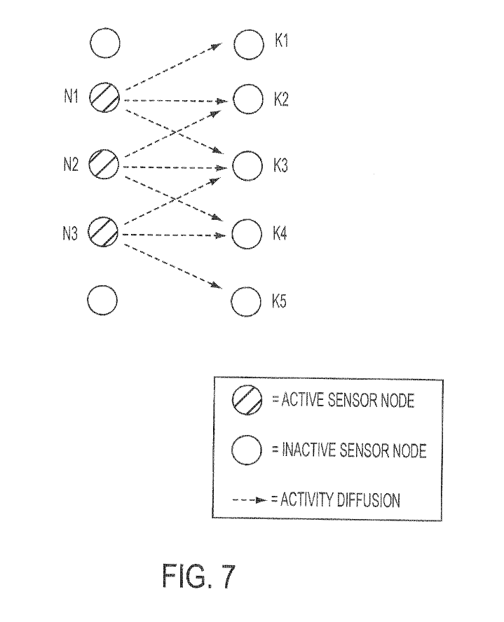

FIG. 7 is an example of activity diffusion according to an exemplary embodiment of the present invention.

Referring to FIG. 7, while nodes N₁, N₂ and N₃ start data aggregation, they also send activity diffusion messages to their next-hop neighborhoods. In this case, the activity messages (containing node activity weights) are spread to K₁, K₂, K₃, K_{4,} and K₅.

When a node in the next layer (closer to the sink node) receives activity diffusion messages, it accumulates them by summing up all the activity diffusion weights it received. When the node's activity diffusion weight is greater than a threshold, it will “fire” like a neuron to become an “aggregation candidate node.”

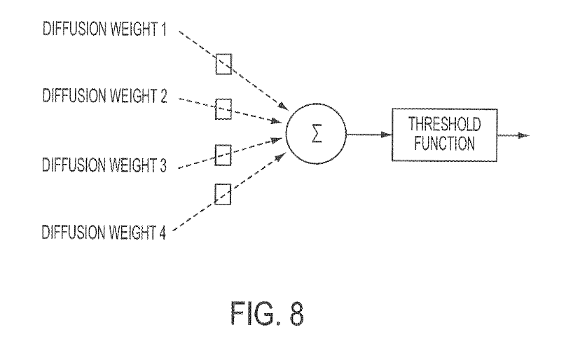

FIG. 8 is an example of diffusion weight calculation according to an exemplary embodiment of the present invention.

Referring to FIG. 8, when a node in the previous layer finishes its data aggregation (its aggregation interval is almost reached), it selects a neighbor from the “aggregation candidate nodes” in the next layer. The higher the diffusion weight that an “aggregation candidate node” has, the higher the probability that it will be chosen. This can be realized by sending a probe message to its next layer neighbors. Then all these neighbors send back their current node diffusion weights. Here it is assumed that each node maintains a set of neighbor node addresses by exchanging info with its neighbors.

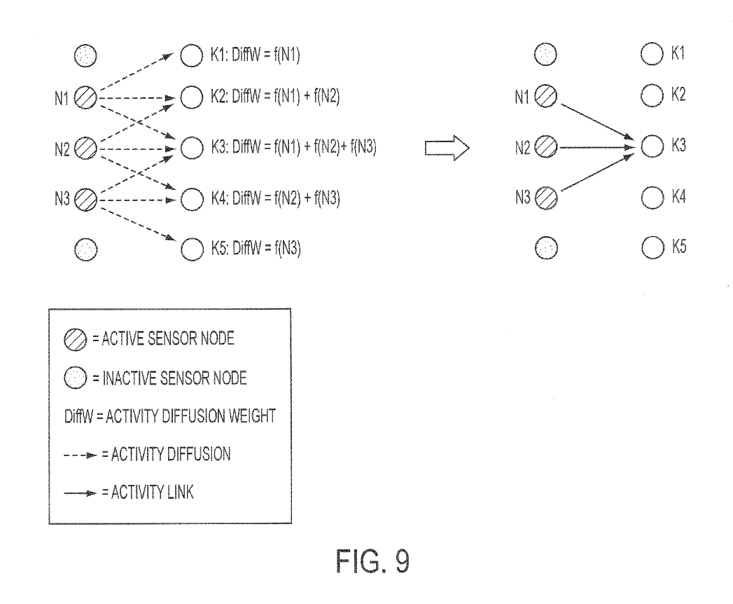

FIG. 9 is an example of aggregation-driven topology formation according to an exemplary embodiment of the present invention.

Referring to FIG. 9, sensor nodes N₁, N₂ and N₃ spread activity diffusion messages f(N₁), f(N₂), and f(N₃) to their neighbors while they started a new data aggregation interval. Each node Ki in the next layer receives the activity diffusion messages and accumulates the activity diffusion weights. It is clear that K₃ has the highest activity diffusion weights (assume f(Ni)=1 in this example).

When a node N₁, N₂, or N₃ finishes data aggregation and is ready to send the data, it will choose the neighbor (next-hop) node with the highest aggregation weight. In this example, it is K₃. By choosing K₃, it actually realizes spatial aggregation (meet at the same place) and temporal aggregation (meet at the same time). Each activity diffusion weight can have temporal information and decays with time. It is only strengthened when a set of nodes are active almost at the same time. For example, if N₁, N₂, or N₃ are active almost at the same time, it will create strong activity diffusion weight at K₃ and encourage the aggregation to meet at the same time period.

During the random phase, each sensor node saves its next hop choice history (e.g. up to Hn records). When the sensor node saves up enough history (greater than a threshold, e.g., Hn records), it transitions to the hub-forming scale free phase. In this phase, a “preferential neighborhood” approach is applied.

Based on the neighbor choice history of the random phase, a sensor node chooses K most preferred neighbors (e.g., finds the top K most frequently chosen neighbors in the history entries) and uses them as next hop candidates. The most preferred neighbors can be thought of as the “hubs”, which are the most possible nodes for efficient spatial and temporal data aggregation.

During each aggregation interval, each sensor node only sends the activity diffusion messages to the K most preferred neighbor nodes. When its aggregation interval is up, the sensor node only queries its K most preferred neighbors and chooses the node with the highest aggregation weight from its preferred neighbors as next hop.

In the hub forming scale free phase, the sensor node uses the preferential neighborhood attach approach to choose from among the most preferred neighbors for the next hop. In comparison with the random phase, the sensor node does not need to exchange messages with all its neighbor nodes. This greatly reduces message exchanges and saves the sensor node energy.

During the hub forming scale free phase, if any damage occurs to the chosen preferred neighbor nodes, the sensor node can replace the damaged preferred nodes from its next candidate(s) in its random phase history. If all preferred neighbor nodes are damaged, the sensor node can return to the random phase.

A topology phase transition to the star phase according to an exemplary embodiment of the present invention will now be described in more detail.

During the hub forming scale free phase, each node remembers its next hop choice history (e.g., it keeps M records). If the next hub choice history shows the stability (e.g. always choose 1 node as next hop more than a predetermined threshold, for example, 80% of the time), the stabilized node can be chosen as a fixed next hop connection as follows:

(1) A Sensor Node P chooses the most frequently chosen node as the fixed/connected next hop when its connection stability criteria are met.

(2) If the Sensor Node P has the fixed next hop, it will not send any activity diffusion message to the next hop during each aggregation interval. Instead, it directly uses the fixed/connected next hop for optimized data aggregation.

(3) If the sensor node P chooses a next hop node N as a fixed connected node, the sensor node P will notify the chosen next hop node, N. Next hop sensor node N will store this sensor node as its fixed connected node, and will also store node P's aggregation interval. For diffusion weight calculation, sensor node N can automatically simulate the sensor node P's activity diffusion based on sensor node P's aggregation interval (e.g., when sensor node P's new aggregation interval starts, sensor node N will add sensor node P's aggregation weight into its accumulated aggregation weight, and node P's aggregation weight decays with time). By using this approach, the activity diffusion weight approach is maintained. Meanwhile, no activity diffusion message is needed according to this exemplary embodiment.

(4) If the sensor node P is damaged and next hop sensor node N does not receive the sensor data from the previous layer sensor node P within a certain data aggregation interval, sensor node N will remove sensor node P from its fixed connection. If the next hop fixed node N is damaged, the sensor node P can choose the second most frequently chosen node as fixed next hop. If no node in the history meets the stability-criteria, then the sensor node N goes back to the hub forming scale free phase.

Note that this approach is not limited to 3 phase transition. Depending on different application requirements, the phase transition can be applied in a flexible way. For example, the nodes can also be configured to transition from the random phase directly to the star phase.

By applying a biology inspired topological phase transition to WSNs, an energy-efficient, adaptive and self-organizing network is formed. It has at least the following advantages:
Adaptive and energy efficient: The topologies of wireless sensor networks are adaptive to sensor's activity pattern to achieve optimized sensor operations and energy efficiency.
Self-Organization: Each node uses simple neighbor-to-neighbor interactions. All nodes together achieve the global goal—an efficient and adaptive WSN.
Scalability: The algorithm is decentralized and self-organized. It is scalable and easy to add new nodes.
Optimization: No fixed topology needs to be maintained. Its topology is optimized based on the resources and activity pattern of wireless sensor nodes.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for a topological phase transition of a Wireless Sensor Network (WSN) comprising a plurality of wireless sensor nodes, the method comprising:
determining an optimal topological phase of the WSN; and
at each wireless sensor node, establishing connections to other wireless sensor nodes in the WSN in accordance with the determined optimal topological phase.

2. The method according to claim 1, further comprising:
at each wireless sensor node, dynamically determining the optimal topological phase;
at each wireless sensor node, establishing connections to other nodes according to the determined optimal topological phase.

3. The method according to claim 1, wherein the optimal topological phase is determined in accordance with at least one of an internal state of each wireless sensor node, a detected sensor data of each wireless sensor node, and a connectivity state of each wireless node.

4. The method according to claim 3, wherein the internal state comprises at least one of a time of a clock, a remaining power level of a power supply, a charge/discharge rate of the power supply, an available communication bandwidth of each wireless sensor node, a rate of sensor data collection of each wireless sensor node, and a rate of data relaying of each wireless sensor node.

5. The method according to claim 3, wherein the connectivity state comprises at least one of a connectivity status of each wireless sensor node, a connectivity history of each wireless sensor node, and a connectivity aggregation weight of each wireless sensor node.

6. The method according to claim 1, wherein the optimal topological phase comprises one of a random graph network, a scale-free network, and a star network.

7. The method according to claim 1, further comprising:
at each wireless sensor node, aggregating sensor data;
at each wireless sensor node, transmitting activity diffusion messages to next hop neighbor wireless sensor nodes;
at wireless sensor nodes, receiving the activity diffusion messages, accumulating the activity diffusion messages and, when an activity diffusion weight of received activity diffusion messages exceeds a threshold value, transmitting a message indicating it is an aggregation candidate node; and
at each wireless sensor node, when a data aggregation is complete, selecting an aggregation candidate node and transmitting the aggregated sensor data to the aggregation candidate node,
wherein the determined optimal topological phase comprises a star network.

8. The method according to claim 7, wherein the selecting of the aggregation candidate node comprises selecting an aggregation candidate node comprising a highest activity diffusion weight at the time of the selecting.

9. The method according to claim 1, further comprising:
at each wireless sensor node, choosing K most preferred neighbor wireless sensor nodes, based on the wireless sensor node's neighbor choice history, and using the K most preferred neighbor wireless sensor nodes as next hop candidates; and
at each wireless sensor node, sending activity diffusion messages to only the K most preferred neighbor wireless sensor nodes during an aggregation interval and, when the aggregation interval elapses, selecting one of the K most preferred neighbor wireless sensor nodes as a next hop;
wherein the optimal topological phase comprises a scale free network.

10. The method according to claim 9, wherein the selecting of the next hop comprises selecting a preferred neighbor wireless sensor node comprising a highest aggregation weight.

11. The method according to claim 1, further comprising:
at each wireless sensor node, storing a history of next hop choices; and
if the next hop choice history shows a neighbor wireless sensor node is chosen as the next hop as frequently as at least a predetermined threshold indicating stability, choosing the stable next hop as a fixed next hop,
wherein the optimal topological phase comprises a star network.

12. The method according to claim 11, further comprising, if a wireless sensor node has a fixed next hop, refraining from sending activity diffusion messages during an aggregation interval and instead directly using the fixed next hop for data aggregation.

13. The method according to claim 11, further comprising:
notifying the fixed next hop that it is chosen as a fixed next hop; and
at the next hop, storing an identity and an aggregation interval of the choosing wireless sensor node.

14. A wireless sensor node for a Wireless Sensor Network (WSN) comprising a plurality of the wireless sensor nodes, the node comprising:
a controller for controlling operations of the node;
a wireless transmitter for transmitting communications from the node;
a wireless receiver for receiving communications;
a sensor unit for sensing sensor data; and
a memory unit for storing the sensor data,
wherein the controller controls the node to connect to other nodes or to an external WSN access point in accordance with a determined optimal topological phase of the WSN.

15. The node according to claim 14, wherein the controller dynamically determines the optimal topological phase.

16. The node according to claim 14, wherein the optimal topological phase is determined in accordance with at least one of an internal state of the node, a detected sensor data from the sensor unit, and a connectivity state of the node.

17. The node according to claim 16, wherein the internal state comprises at least one of a time of a clock, a remaining power level of a power supply, a charge/discharge rate of the power supply, an available communication bandwidth of the node, a rate of sensor data collection of the sensor unit, and a rate of data relaying of the node.

18. The node according to claim 16, wherein the connectivity state comprises at least one of a connectivity status of the node, a connectivity history of the node, and a connectivity aggregation weight of the node.

19. The node according to claim 14, wherein the optimal topological phase comprises one of a random graph network, a scale-free network, and a star network.

20. The node according to claim 14, wherein:
the node aggregates sensor data and transmits activity diffusion messages to next hop neighbor nodes,
if the node receives the activity diffusion messages, the node accumulates the activity diffusion messages and, when an activity diffusion weight of received activity diffusion messages exceeds a threshold value, transmits a message indicating it is an aggregation candidate node,
when a data aggregation is complete, the node selects an aggregation candidate node and transmits the aggregated sensor data to the aggregation candidate node, and
the determined optimal topological phase comprises a star network.

21. The node according to claim 20, wherein the selecting of the aggregation candidate node comprises selecting an aggregation candidate node comprising a highest activity diffusion weight at the time of the selecting.

22. The node according to claim 14, wherein:
the node chooses K most preferred neighbor nodes, based on the node's neighbor choice history, and uses the K most preferred neighbor nodes as next hop candidates,
the node sends activity diffusion messages to only the K most preferred neighbor nodes during an aggregation interval and, when the aggregation interval elapses, selecting one of the K most preferred neighbor nodes as a next hop, and
the optimal topological phase comprises a scale free network.

23. The node according to claim 22, wherein the selecting of the next hop comprises selecting a preferred neighbor node comprising a highest aggregation weight.

24. The method according to claim 14, wherein:
the node stores a history of next hop choices, and
if the next hop choice history shows a neighbor node is chosen as the next hop as frequently as at least a predetermined threshold indicating stability, the node chooses the stable next hop as a fixed next hop,
wherein the optimal topological phase comprises a star network.

25. The node according to claim 24, wherein if the node has a fixed next hop, the node refrains from sending activity diffusion messages during an aggregation interval and instead directly uses the fixed next hop for data aggregation.

26. The node according to claim 24, wherein:
the node notifies the fixed next hop that it is chosen as a fixed next hop, and
the next hop stores an identity and an aggregation interval of the choosing node.

27. A Wireless Sensor Network (WSN), the WSN comprising:
a plurality of wireless sensor nodes,
wherein each wireless sensor node dynamically connects to other wireless sensor nodes in accordance with a determined optimal topological phase.

28. The WSN according to claim 27, wherein each wireless sensor node separately dynamically determines its optimal topological phase.
